(19) United States
(12) Patent Application Publication
(10) Pub. No.: US 2026/0044866 A1
(43) Pub. Date: Feb. 12, 2026

(54) SYSTEMS AND METHODS FOR THE CERTIFICATION OF MEDIA FILES CREATED WITHOUT GENERATIVE ARTIFICIAL INTELLIGENCE

(71) Applicant: LJPIP LLC, Chicago, IL (US)

(72) Inventors: LILIAN DAVIDSON MCGRADY, Chicago, IL (US); JASON BARRY ELSTER, Chicago, IL (US); PAUL DAVID MCGRADY, JR., Chicago, IL (US)

(73) Assignee: LJPIP LLC, Chicago, IL (US)

(21) Appl. No.: 19/295,101

(22) Filed: Aug. 8, 2025

Related U.S. Application Data
(60) Provisional application No. 63/681,609, filed on Aug. 9, 2024.

(51) Int. Cl. G06Q 30/018

(52) U.S. Cl. CPC G06Q 30/0185

(57) ABSTRACT

Systems and methods disclosed herein provide the capability for certification of media files as being free of generative artificial intelligence (GAI) content. Via use of the systems and methods, consumers can elect to consume media that is free of GAI content.

### CROSS-REFERENCE TO RELATED APPLICATION

This application claims priority to and the benefit of U.S. Provisional Application No. 63/681,609 filed Aug. 9, 2024, entitled “SYSTEMS AND METHODS FOR THE CERTIFICATION OF MEDIA FILES CREATED WITHOUT GENERATIVE ARTIFICIAL INTELLIGENCE.” The foregoing application is hereby incorporated by reference in its entirety, including but not limited to those portions that specifically appear hereinafter, but except for any subject matter disclaimers or disavowals, and except to the extent that the incorporated material is inconsistent with the express disclosure herein, in which case the language in this disclosure shall control.

### TECHNICAL FIELD

The present disclosure relates to systems and methods for analyzing and organizing media files, and in particular to, the certification of media files as not developed with generative artificial intelligence.

### BACKGROUND

The use of generative artificial intelligence (GAI) has rapidly grown across many industries, one of which is the artistic media industry. Music, sound effects, and voice effects can now be easily created and replicated to generate new compositions and soundtracks, often without any direct human intervention. Such uses are controversial, with some in the relevant market spaces preferring to consume and use media produced without the use of GAL. However, GAI operates at such an advanced level that it can be difficult to recognize if a certain piece of media is created with or without it. As such, there is a need for a process to identify, certify, and label media that was created without the use of GAI.

### SUMMARY

Systems and methods for certifying media files and generating a database of non-AI media files are disclosed herein. The method may comprise: receiving, by one or more servers, author data corresponding to identifying information for an author, verifying, by the one or more servers and through a verification process, an identity of the author, receiving, by the one or more servers and through an uploading process, one or more media files corresponding to one or more unique works associated with the author, receiving, by the one or more servers and through a certification process, a certification that at least one of the one or more unique works associated with the author was created without the use of generative artificial intelligence, generating, by the one or more servers, a notification that the certification was successful, and updating one or more databases to associate a certification indicator with the at least one of the one or more unique works in response to the certification process being completed to produce a plurality of certified media files.

In various embodiments, the method may further comprise transmitting, by the one or more servers, the plurality of certified media files to one or more external databases, wherein the one or more external databases are in electronic communication with a media platform. In various embodiments the method may further comprise sorting, by a toggle, the one or more external databases into the plurality of certified media files and a plurality of non-certified media files, wherein the plurality of certified media files comprise the certification indicator and displaying the plurality of certified media files on a user device.

In various embodiments, the method may further comprise storing, by the one or more servers, an aggregation of certified media files. In various embodiments, the method may further comprise auditing, through an auditing process, all or a portion of the aggregation of certified media files to verify a certification status. In various embodiments, the certification indicator is a visible feature on the media platform spatially located near other visible metadata associated with the plurality of certified media files.

### BRIEF DESCRIPTION OF THE DRAWINGS

With reference to the following description and accompanying drawings:

FIG. 1 illustrates a schematic view of a certification system, in accordance with various embodiments.

FIG. 2 illustrates a method for certifying a media file, in accordance with various embodiments.

FIGS. 3-18 illustrate an author user interface for the certification system of FIG. 1 and performing the method of FIG. 2, in accordance with various embodiments.

FIGS. 19-20 illustrate a consumer user interface for a media platform that is synchronized with the certification system of FIG. 1, in accordance with various embodiments.

### DETAILED DESCRIPTION

The detailed description of various embodiments herein refer to the accompanying drawings and pictures, which show various embodiments by way of illustration. While these various embodiments are described in sufficient detail to enable those skilled in the art to practice the disclosure, it should be understood that other embodiments may be realized, and that logical, communicative, functional, and/or similar changes may be made without departing from the spirit and scope of the disclosure. Thus, the detailed description herein is presented for purposes of illustration only and not of limitation. For example, the steps recited in any of the method or process descriptions may be executed in any suitable order and are not limited to the order presented. Moreover, any of the functions or steps may be outsourced to or performed by one or more third parties. Modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used herein, “each” refers to each member of a set or each member of a subset of a set. Furthermore, any reference to singular includes plural embodiments, and any reference to more than one component may include a singular embodiment. Although specific advantages have been enumerated herein, various embodiments may include some, none, or all the enumerated advantages.

Various embodiments discussed herein are explained in connection with certification of music or other audio files. However, it will be appreciated that principles of the present disclosure are applicable to and may be utilized in connection with a wide variety of creative works, including but not limited to music, books, sculpture, paintings, murals, plays and screenplays, comics, magazines and other periodicals, audiovisual files, slideshows, mixed media, and so forth. All such uses and applications are considered to be within the scope of the present disclosure. Additionally, it will be appreciated that principles of the present disclosure may be applied to verify the “humanness” and identity of an author or creator (e.g., verify that the creator is a human being rather than a GAI system or other non-human system).

Principles of the present disclosure contemplate the use of a media file certification and sorting method and system configured for use by consumers and authors. For example, the systems and methods disclosed herein leverage technology and human ingenuity, align incentives for the entire music ecosystem, including fans, and provide a credible and clear future for “human” works or art (e.g., music created without the use of GAI). By doing so, it provides a certification to fans, artists (upstream and downstream), publishers, labels, distributors, and other industry players that the art is “clean” of GAL. The certification and sorting system may be configured to allow consumers to quickly identify media files “clean” of GAI, as well as provide authors the ability to certify their own works as “clean.” In particular, as described herein, “clean” refers to media files developed and produced without the use of or contributions from GAL. In various embodiments, an exemplary method may comprise or utilize an author user interface (UI) and one or more consumer UIs.

The author UI may allow an author, such as, for example, an artist, publisher, producer, or label, to verify their identity and that they are an individual human (i.e., not a bot or AI), upload unique works (e.g., songs, sound effects, or other media as noted above) to a certification database, affirm under oath that said work is clean, and receive certification license allowing the author to assign one or more certification indicators to the work(s). In particular, as described herein, “unique works” refers to any work of art by an author or creator, such as, for example, an audio work, painting, movie, video, television program, photograph, writing, print or digital media, mixed media, and/or any combination of the same. The consumer UI may allow a consumer to view works assigned the certification indicator on a search results page on a media platform, sort a compilation of works by their certification indicator or lack thereof, and otherwise interact with or utilize clean media.

Disclosed herein is a system that intakes media metadata (e.g., music or music metadata, such as song numbers, video data, or written data) both written and performed, provides an opportunity for author or creator (e.g., artist for music) to affirm under oath that the music contains no GAI components, verifies the humanity and identity of the submitting artist, provides for routine and specific audits (e.g., periodic, continual, or sporadic) of the representations made under oath, and issues a certification indicator (e.g., a unique identifier for the media file and a license to use one or more certification marks in commercial uses of the certified media file) indicating that the registered media (e.g., audio music, music video, video, book, or any other media or creative content that may be readily apparent to one skilled in the art) is fully human-made.

An exemplary system disclosed herein can then be configured to sync with various media platforms as described further herein, which can allow a consumer to toggle (i.e., filter) between all media files (e.g., music with or without GAI) and non-GAI media files only (e.g., music that includes the certification on their platforms) which will filter-in media files that bear the certification indicator (e.g., a certification mark in the metadata) and will also allow for display of the certification indicator in connection with the media file on the platform. In various embodiments, the display of the certification indicator aside the media file on the platform may be visible at all times, even if the platform is not filtered to display only non-GAI media files. Although described herein with respect to a specific use case for media files (i.e., music), the present disclosure is not limited in this regard. For example, any unique works that are created by an author, such as paintings, photographs, books, movies, screenplays, scripts, art, or any other unique work that may be readily apparent to one skilled in the art is within the scope of this disclosure.

As described further herein, in various embodiments, the process for an author (e.g., an artist) for registering and certifying music as being created without GAI, can comprise the following steps. First, an artist can land at a home page through a user interface of a computer system. The home page contains information about the products, links to the terms of service and privacy policy, and other relevant links, such as, for example, a link to a merchandise shop. Responsive to selecting a registration link, an artist is taken to a screen where the artist is asked to create an account. Information is then obtained from the artist which can include a stage name, kind of performer, or any other information that may be readily apparent to one skilled in the art. Next, the artist can be sent to a page for payment and membership selection. After membership selection, the artist can verify his or her identity based on an identification process (e.g., using PLAID® or any other identity verification solution that may be readily apparent to one skilled in the art). The identify verification may include identification verification by documents (e.g., license or passport verification), by answering questions, by providing a picture, by a review of live webcam video, and/or any other process that may be readily apparent to one skilled in the art.

After registration, the user interface enables the artist to affirm under oath that specific media files are clean and will issue a license to the artist that will allow them to use the one or more certification indicators in association with the media files. In various embodiments, the user interface may automatically tag the respective media files with the certification indicator in respective media platforms. After registration, the artist can be provided with links to the limited certification mark license(s), the brand guidelines for the use of the certification indicator(s), share the news about the certification indicator(s) on social media, refer friends, and/or upload songs individually, or bulk uploads songs collectively for association with the certification indicator(s). In various embodiments, the systems and methods disclosed herein leverage human intelligence and specialization (e.g., musicologist or music technologist for music media files, or similar trained specialists for video files, image files, and so forth) to help identify the influence of GAI in media files submitted to the certification system for certification. For example, as described further herein, some or all the media files that are collected by the systems and methods disclosed herein can be periodically (or sporadically) audited to confirm that the media file was created without GAI.

In various embodiments, the audit can be performed by a specialist (e.g., a musicologist or a music technologist). In various embodiments, after a significant amount of data has been audited and confirmed by a music technologist, a sufficient training data set may be created for training a machine learning model to assist in the auditing process. In this regard, based on a threshold level of media data that was created without the use of GAI and that was audited by a specialist, a training data set for a machine learning model may be created that utilizes the media data that is known to not include GAI and media data that is known to include GAI to train a model to detect whether GAI was utilized in creation of an unknown media file. Accordingly, the systems and methods disclosed herein can facilitate the creation of an automated detection system for determining whether an unknown media file is likely to have utilized GAI or not, which can be incorporated into the systems and methods disclosed herein, in accordance with various embodiments. It will be appreciated that multiple models may be used in the system, for example one model directed to detection of use of GAI in music files, another model directed to detection of use of GAI in video files, yet another model directed to detection of use of GAI in image files, and so forth. Moreover, one model may be trained to detect the use of GAI in more than one form of media file.

In various embodiments, the systems and methods disclosed herein allow fully human-made media files to be distinguishable in the marketplace from GAI media files and hybrid human/GAI media files, allowing consumers to choose what kind of media they prefer to consume or to incorporate into their own art, thereby preserving a clean human-made music ecosystem.

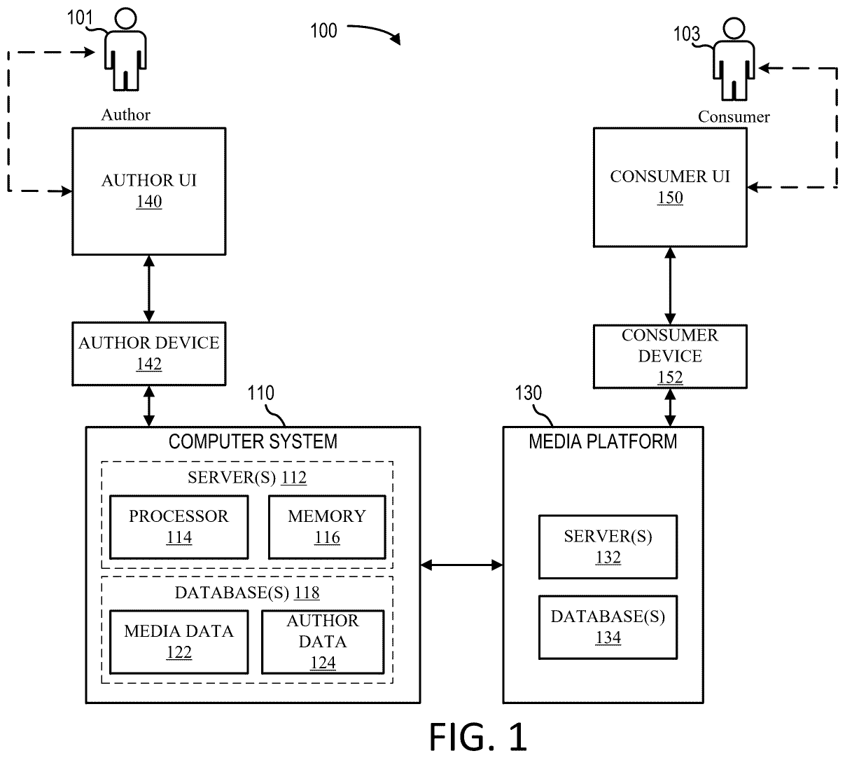

In various embodiments, and with reference now to FIG. 1, a system 100 for certifying and sorting media files is disclosed. In various embodiments, system 100 includes a computer system 110 comprising server(s) 112 and database(s) 118. Each of the one or more servers 112 comprise at least one processor 114 and a memory 116. In various embodiments, computer system 110 may store, utilize, and/or execute a software program configured to perform the methods described herein in the memory 116 and run the software program using the processor 114. Each of the one or more servers 112 may include any number of individual processors 114 and memories 116. It will be appreciated that server(s) 112 may comprise any suitable computing devices, and are not limited to traditional servers operative in datacenters. Additionally, system 100 components may be co-located or contained in a single system; alternatively, system 100 components may be distributed across a shared network, operative in a virtual machine, operative in a cloud computing environment, and so forth.

In various embodiments, the processor 114 retrieves and executes instructions stored in the memory 116 to control the operation of the computer system 110. Any number and type of processor(s) (e.g., an integrated circuit microprocessor, microcontroller, and/or digital signal processor (DSP)), can be used in conjunction with the various embodiments. The processor 114 may include, and/or operate in conjunction with, any other suitable components and features, such as comparators, analog-to-digital converters (ADCs), and/or digital-to-analog converters (DACs). Functionality of various embodiments may also be implemented through various hardware components storing machine-readable instructions, such as application-specific integrated circuits (ASICs), field-programmable gate arrays (FPGAs) and/or complex programmable logic devices (CPLDs).

In various embodiments, the memory 116 may include a non-transitory computer-readable medium (such as on a hard drive or FLASH memory) storing computer-readable instructions stored thereon that can be executed by the processor 114 to perform the methods of the present disclosure. The memory 116 may include any combination of different memory storage devices, such as hard drives, random access memory (RAM), read only memory (ROM), FLASH memory, or any other type of volatile and/or nonvolatile memory.

In various embodiments, system 100 may further comprise or be in communication with author device 142, which may be in electronic communication with computer system 110, directly or via an author UI 140. In various embodiments, author device 142 is configured to transmit author data 124 to database(s) 118. In various embodiments, author data 124 comprises identifying information for an author 101, such as, for example, government name, stage name and/or type of author. Author data 124 may further comprise identity verification data, such as, for example, identity verification questions compiled from public records, identification documents (e.g., state and/or federal identification), self-photographs, video, and/or the like. Author data may be obtained from internal sources and/or external systems or providers.

In various embodiments, author device 142 is further configured to upload and transmit media data 122 to database(s) 118. In various embodiments, media data 122 comprises one or more media files corresponding to unique works associated with author 101. During the uploading, author 101 submits a certification that the unique works were created and produced without the use of GAL. In some exemplary embodiments, after the uploading, system 100 may check or analyze media data 122, for example in connection with a machine learning model as disclosed above, to verify media data 122 appears clean of GAI as certified by author 101. A certification indicator is assigned to media data 122 uploaded to database(s) 118.

In various embodiments, author UI 140 may comprise a graphical user interface (GUI) accessible via a mobile application, web browser, software application, or the like. Author UI may comprise or represent a website or software application that comprises a series of interactive screens wherein author 101 can sign up for an account, submit author data 124, upload media data 122, complete payment processes, and link to external websites, such as, for example, email and social media platforms.

In various embodiments, computer system 110 may be in electronic communication with a media platform 130, which comprises one or more servers 132 and one or more databases 134. In various embodiments, media platform 130 may comprise any media hosting platform configured to provide consumer(s) 103 streaming access to licensed media. Media platform 130 may be peer-to-peer and/or server based, such as, for example, APPLE MUSIC®, SPOTIFY®, PANDORA®, and/or AMAZON MUSIC®, or any other media platform 130 that may be developed in the future or readily apparent to one skilled in the art. Moreover, computer system 110 may be in electronic communication with multiple media platforms 130, including one or more platforms directed to music files, one or more platforms directed to video files, one or more platforms directed to image files, and/or the like. In this manner, computer system 110 may be broadly configured to support ecosystems of clean media files of various types.

In various embodiments, media platform 130 may receive (or retrieve) media data 122 from computer system 110 comprising the certification indicator (e.g., via a syncing process, API, push notification, or similar). In various embodiments, media data 122 comprising the certification indicator can be configured to be displayed through the consumer UI 150 with the certification indicator. In this regard, when scrolling through various media files on the consumer UI 150, each of the media data 122 that is uploaded to the computer system 110 and stored in the one or more databases 118 can automatically be tagged with the certification indicator. In various embodiments, as described further herein, the certification indicator can be tagged after various steps are completed by the author though the author UI 140. In various embodiments, after an author 101 uploads various media files to the one or more databases 118, the media data 122 can be periodically audited. In various embodiments, the audit process can be a manual process or an automated process as described further herein.

In various embodiments, media platform 130 may be configured to electronically communicate with and/or interact with consumer device 152, directly or via consumer UI 150. Consumer UI 150 may comprise a graphical user interface (GUI) accessible via a mobile application, web browser, software application, or the like. For example, consumer device 152 may interact with consumer UI 150 to instruct media platform 130 to conduct a search fora specific artist and display a search results page on consumer device 152. Should the consumer 103 desire to only see certified media data 122 on the search results page, they can use the consumer UI 150 on the consumer device 152 to instruct media platform 130 to switch a toggle configured to filter the search results page and display only media data 122 with the certification indicator.

Author device 142 and consumer device 152 may comprise any suitable hardware, software, and/or database components capable of sending, receiving, and storing data. For example, author device 142 and/or consumer device 152 may comprise a personal computer, personal digital assistant, cellular phone, smartphone (e.g., IPHONE®, ANDROID®, and/or the like), IoT device, a digital juke box, and/or any other device that may be readily apparent to one skilled in the art. Author device 142 and/or consumer device 152 may comprise an operating system, such as, for example, a WINDOWS® mobile operating system, an ANDROID® operating system, APPLE® IOS®, a LINUX® operating system, and the like. Author device 142 and/or consumer device 152 may also comprise software components installed on author device 142 and/or consumer device 152 and configured to enable access to or use of various system 100 components. For example, author device 142 and/or consumer device 152 may comprise a web browser (e.g., MICROSOFT INTERNET EDGE®, GOOGLE CHROME®, etc.), an application, a micro-app or mobile application, or the like, configured to allow the author device 142 and/or consumer device 152 to access and interact with computer system 110 (e.g., directly or via a respective UI, as discussed herein).

Database(s) 118 store and/or compile information related to media, authors or creators, products, and/or packaging, as well as any other desired information (as further discussed herein). The database 118 may be implemented on computer system 110 or hosted by another system or device (such as a server) in communication with the system 100 via, for example, a network such as a LAN or WAN. In various embodiments, database(s) 118 may be implemented as a relational database.

Any of the components in FIG. 1, as well as other systems and components operating with, or as part of, various embodiments may communicate with each other via a network (not shown). In various embodiments, one or more components of system 100 may include a wireless transceiver and the network may comprise a wireless system to allow wireless communication between various systems and devices, such as a wireless mobile telephony network, General Packet Radio Service (GPRS) network, wireless Local Area Network (WLAN), Global System for Mobile Communications (GSM) network, Personal Communication Service (PCS) network, Advanced Mobile Phone System (AMPS) network, and/or a satellite communication network. Such networks may be configured to facilitate communication via any other type of connection, such as a wired Internet connection, a wireless Internet connection, a cellular telephone network connection, a wireless LAN connection, a wireless WAN connection, an optical connection, a USB connection, and/or a mobile device synchronization port connection.

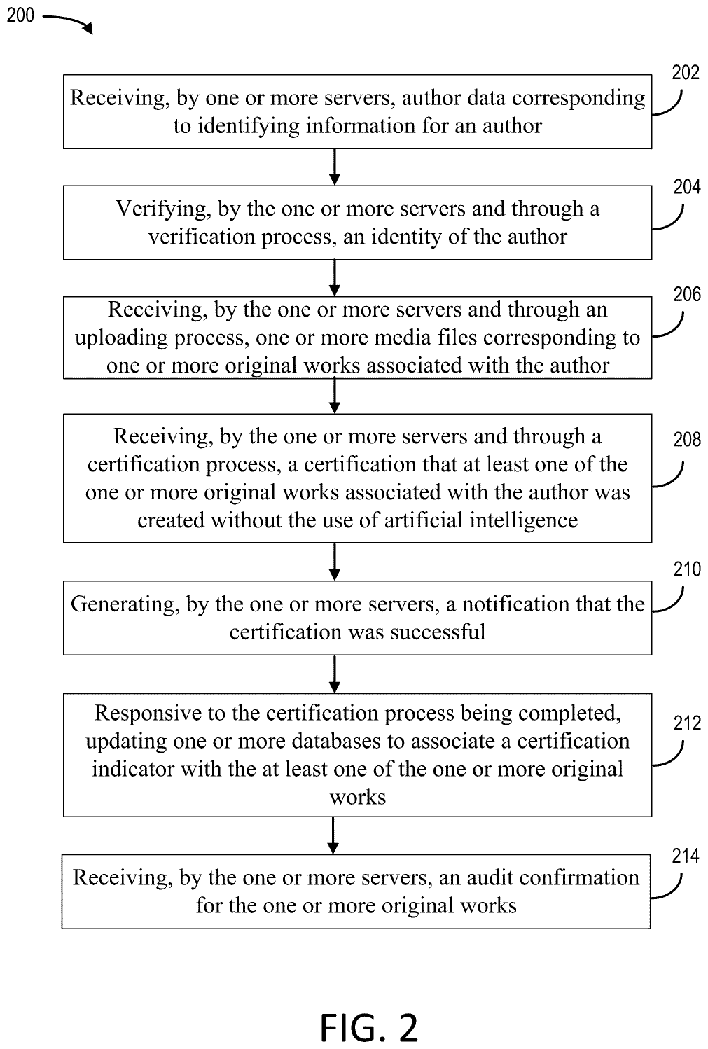

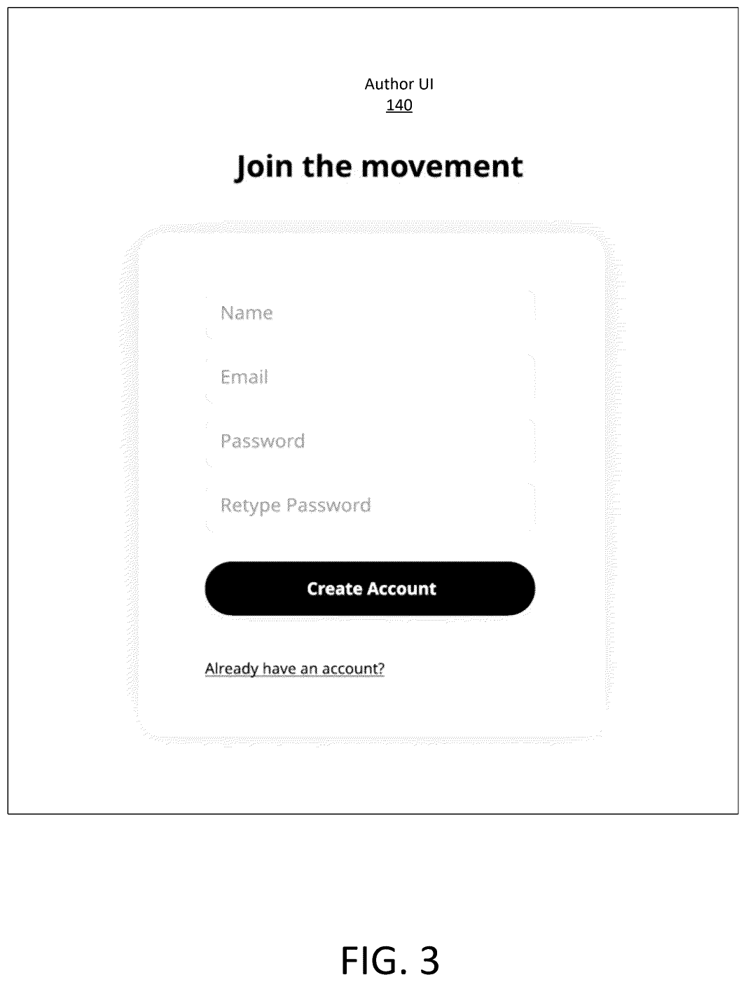

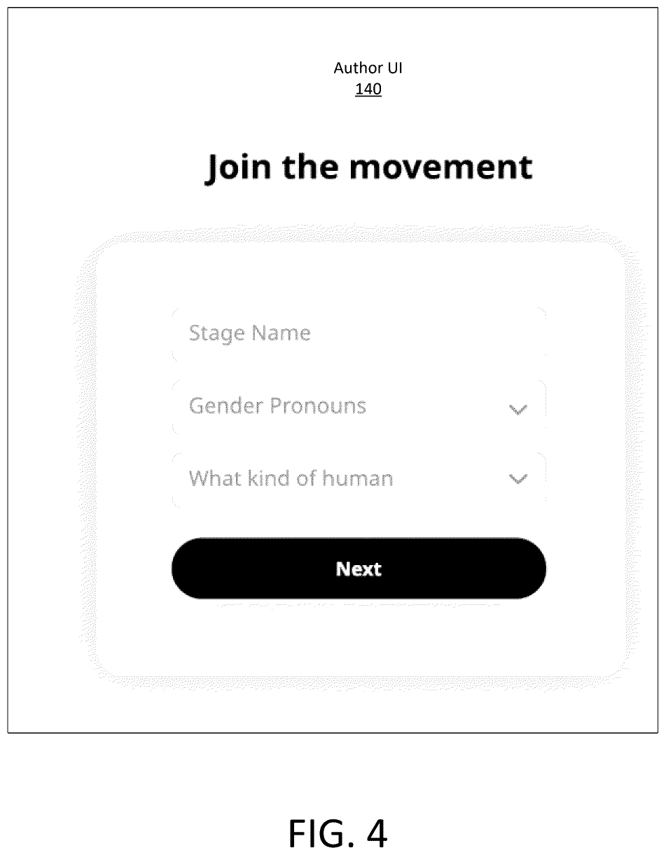

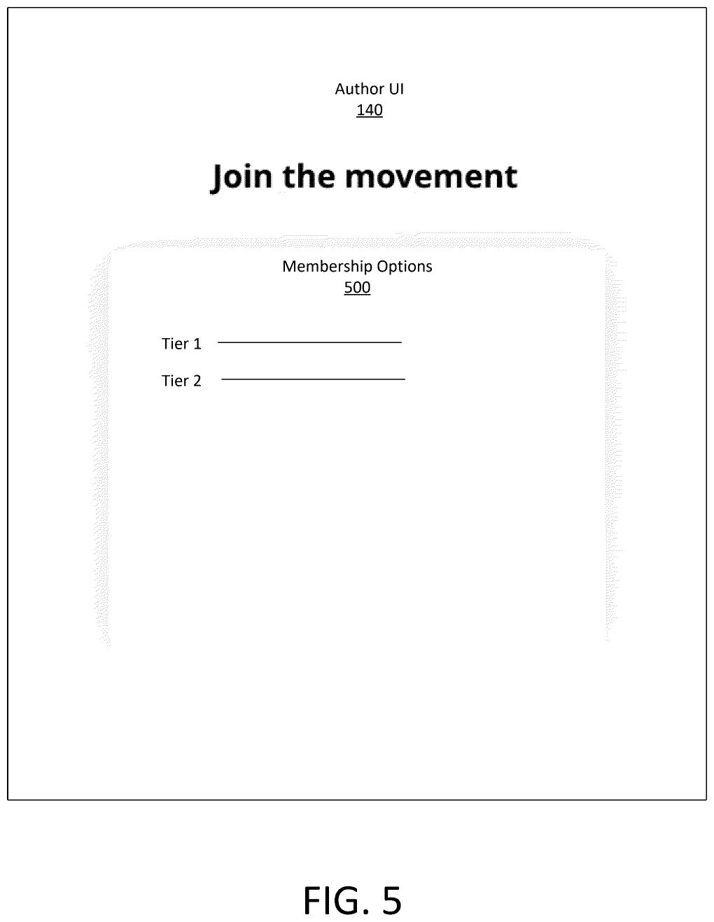

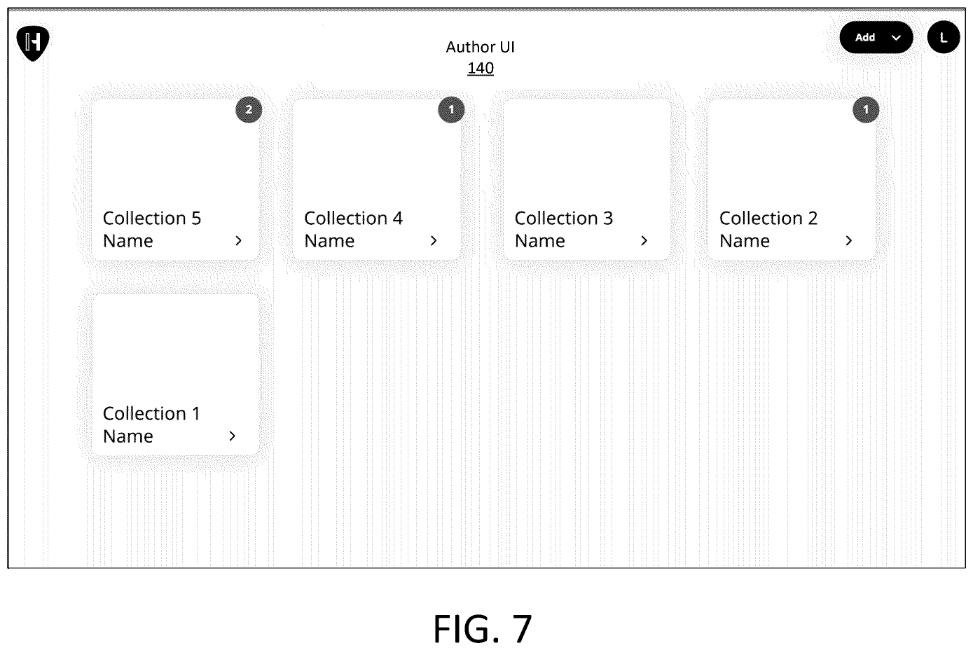

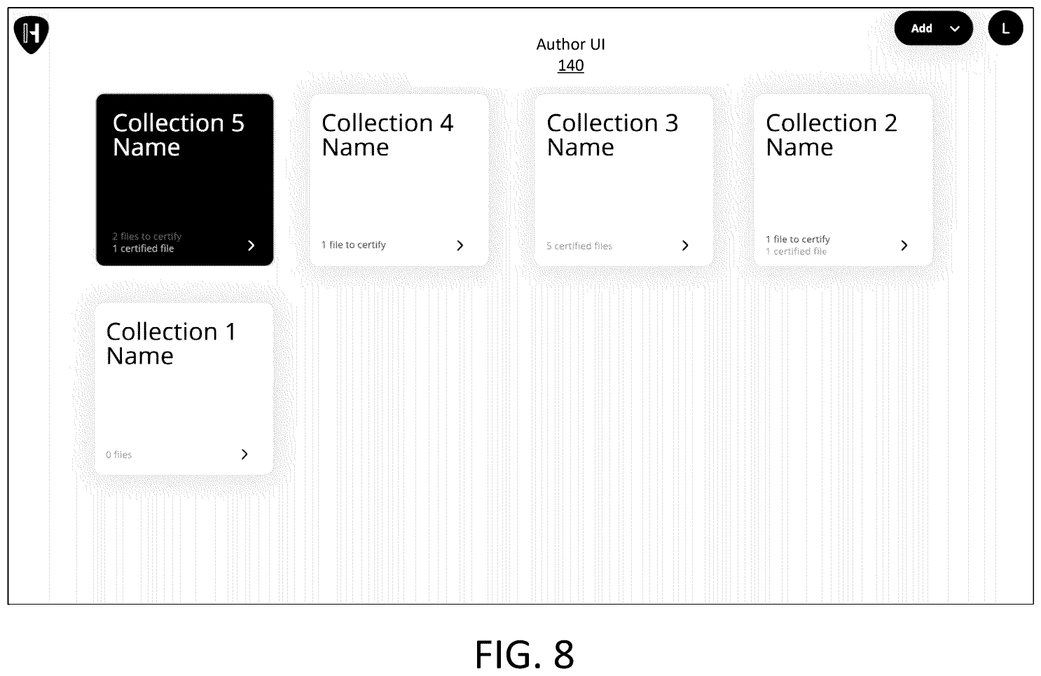

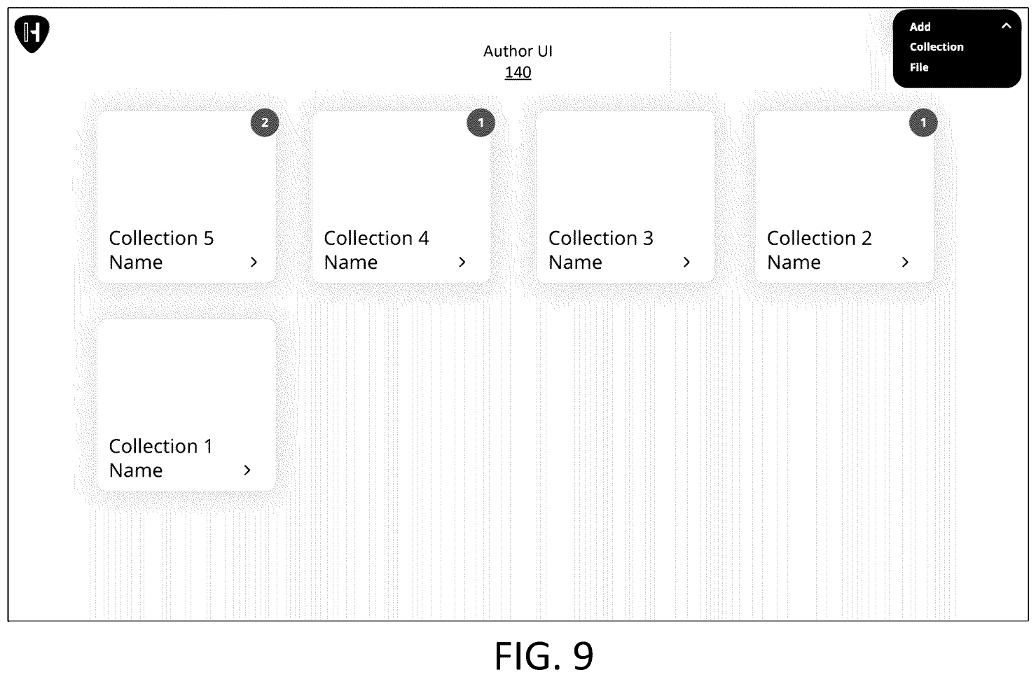

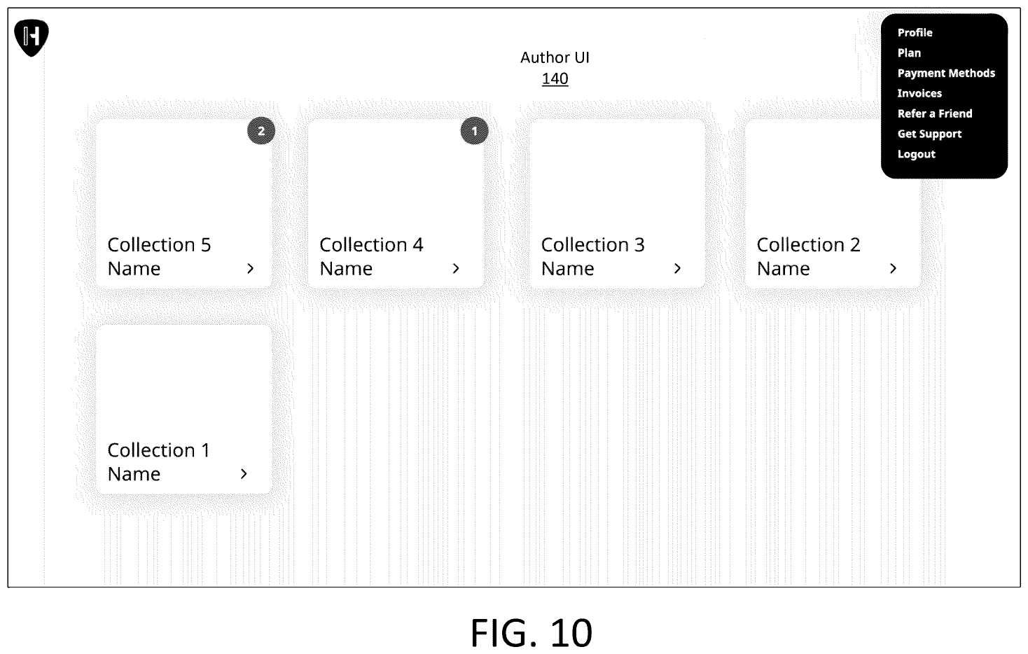

Referring now to FIG. 2, a method 200 performed by the one or more servers 112 of the computer system 110 from FIG. 1 is illustrated, in accordance with various embodiments. With combined reference to FIGS. 1 and 2, the method 200 can comprise receiving, by one or more servers 112, author data 124 corresponding to identifying information for an author 101 (step 202). In various embodiments, the author data 124 is received through the author UI 140. In various embodiments, the author data 124 can be received during creation of an account (e.g., via the author UI 140 as shown in FIGS. 3-6) and/or after creation of an account through uploading of media data (e.g., via the author UI as shown in FIGS. 7-11). The present disclosure is not limited in this regard.

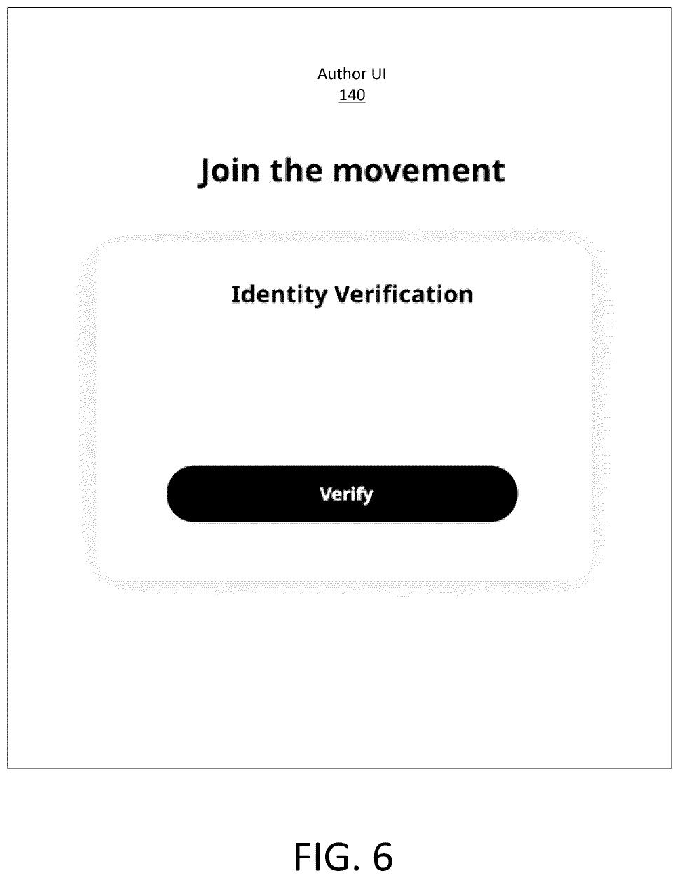

The method 200 can further comprise verifying, by the one or more servers 112 and via a verification process, the identity of the author 101 (step 204). For example, during the registration process, the author UI 140 can include a verification process. Accordingly, responsive to selecting a verify link at a verification step in the method 200 (e.g., as shown in FIG. 6), the author 101 can complete one or more verification steps, such as answering questions, uploading one or more identifying documents, utilizing a third-party verification service, and/or providing a photo or video that matches the one or more identifying documents, in accordance with various embodiments. In this regard, the artist can be identified as a human and the author data 124 can reflect that the identity of the author 101 has been verified in the one or more databases 118.

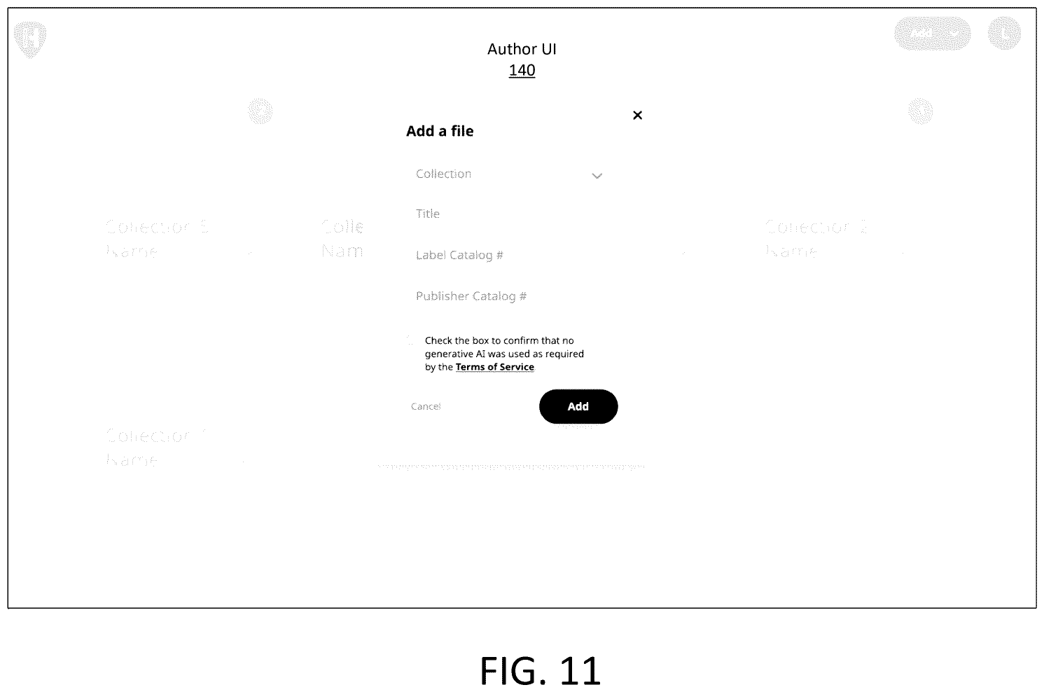

Next, the one or more servers 112 may receive, through an uploading process, one or more media files corresponding to one or more unique works associated with the author 101 (step 206). For example, with reference now to FIGS. 7-11, an author 101 can upload through an author UI 140 one or more media files. The one or more media files can be a collection (e.g., a bulk upload with a plurality of albums) or collections, a bulk upload of a single album or collection, a single song, or any other combination of media files that may be readily apparent to one skilled in the art. In various embodiments, when adding a media file (e.g., as shown in FIG. 11), the author 101 can select a media file type (e.g., song, collection, album, or any other identifier of the media type that may be readily apparent to one skilled in the art), a title of the media file (e.g., a song title, an album title, a collection title, or any other title), one or more unique identifiers for the media file (e.g., a label catalog number, a publisher catalog number or any other unique identifier for a media file that may be readily apparent to one skilled in the art). In various embodiments, during the uploading process, the author 101 may be required to select a box (or make some other confirmation, such as typing an affirmation or oath) that no GAI was used in creation of the media file (e.g., as shown in FIG. 11). Although illustrated as including this step, the present disclosure is not limited in this regard. For example, the check in this step may be meant to notify a user that this will be a requirement for a certification process performed later, and does not have to be included, in accordance with various embodiments.

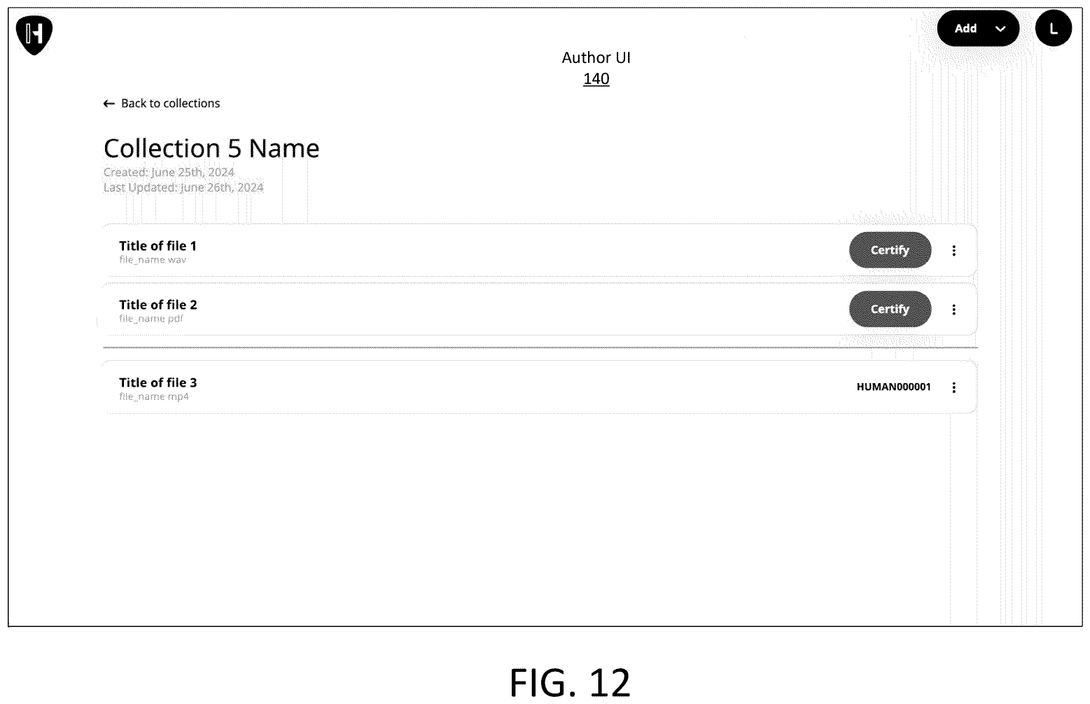

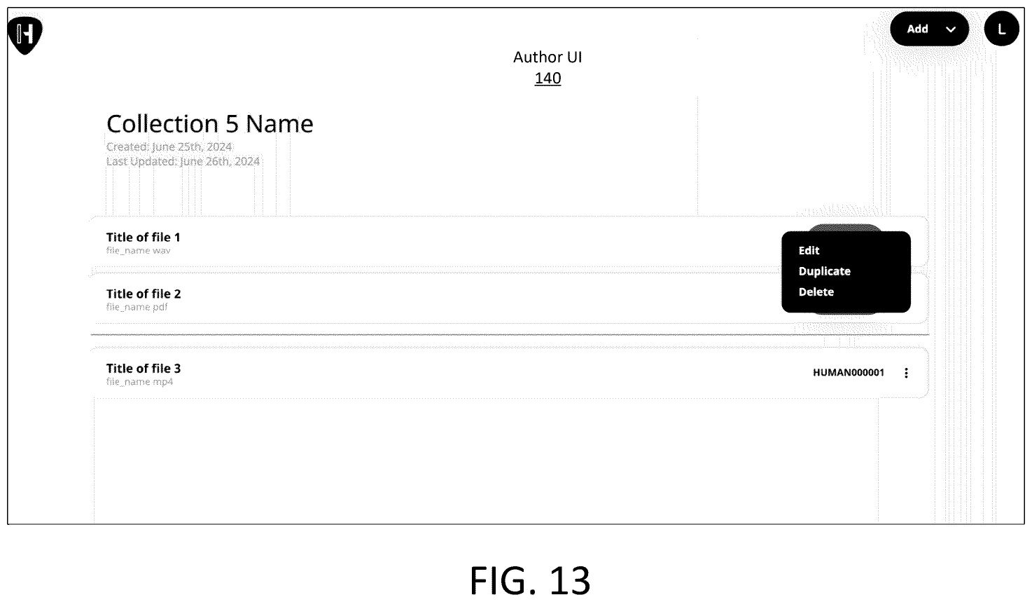

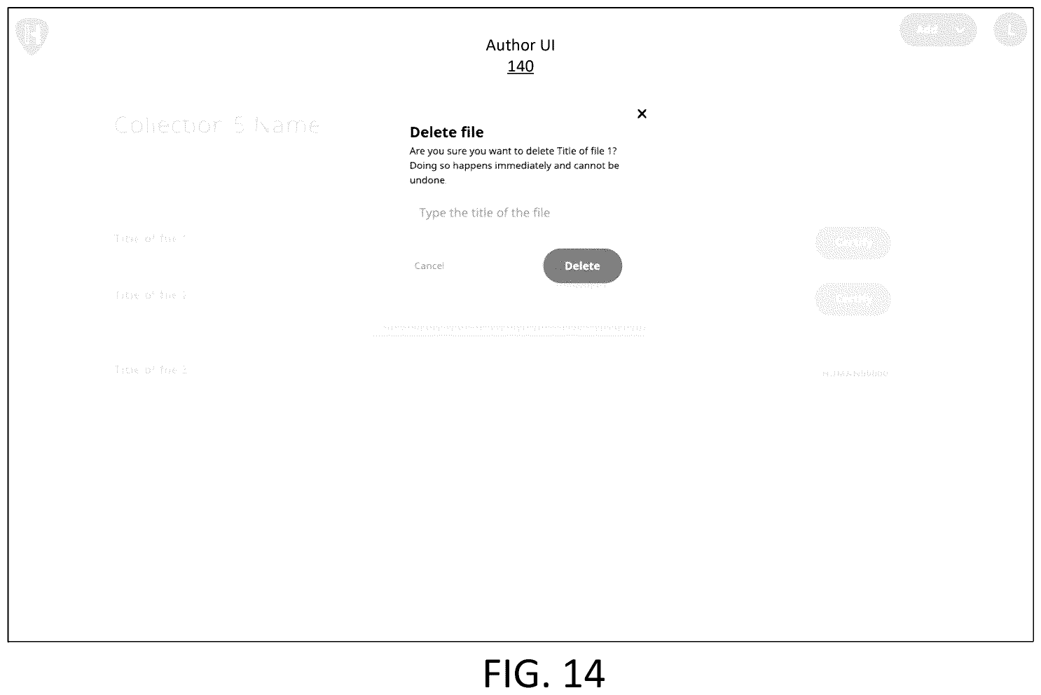

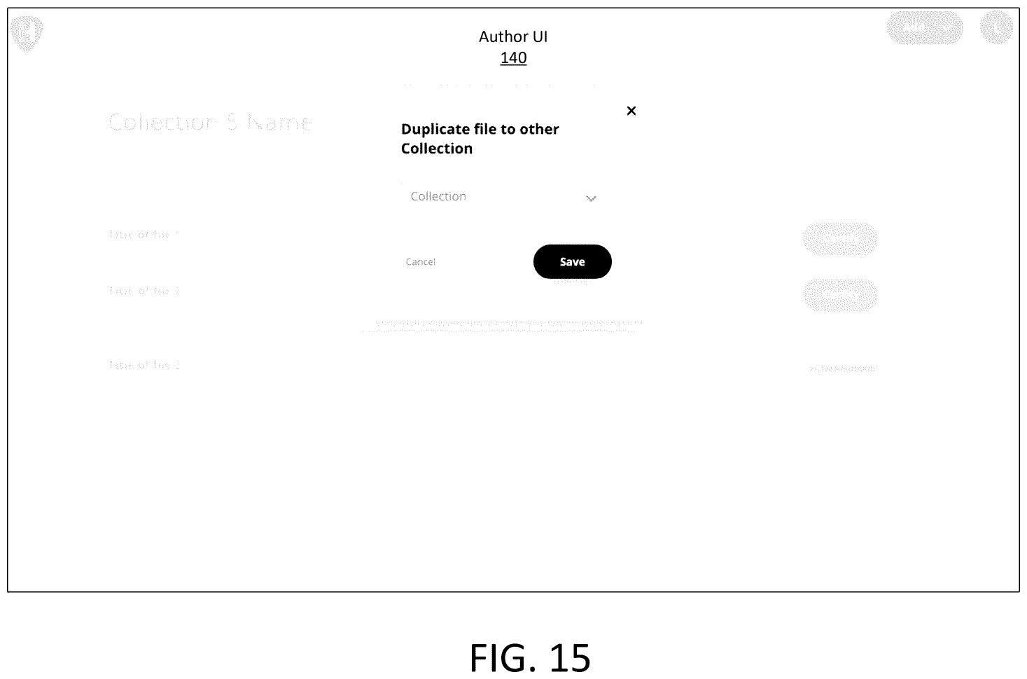

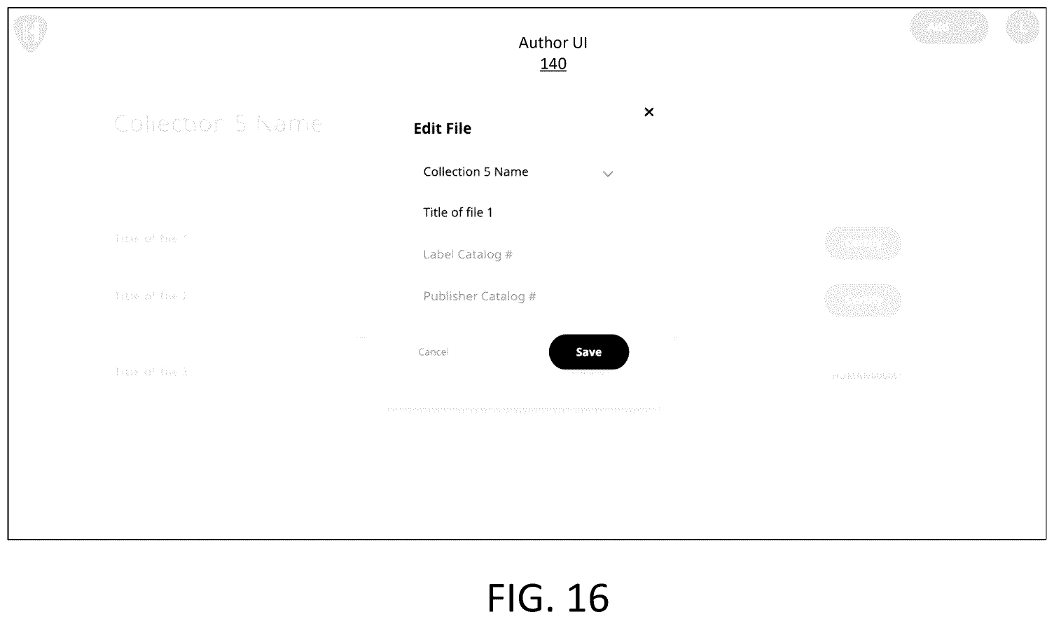

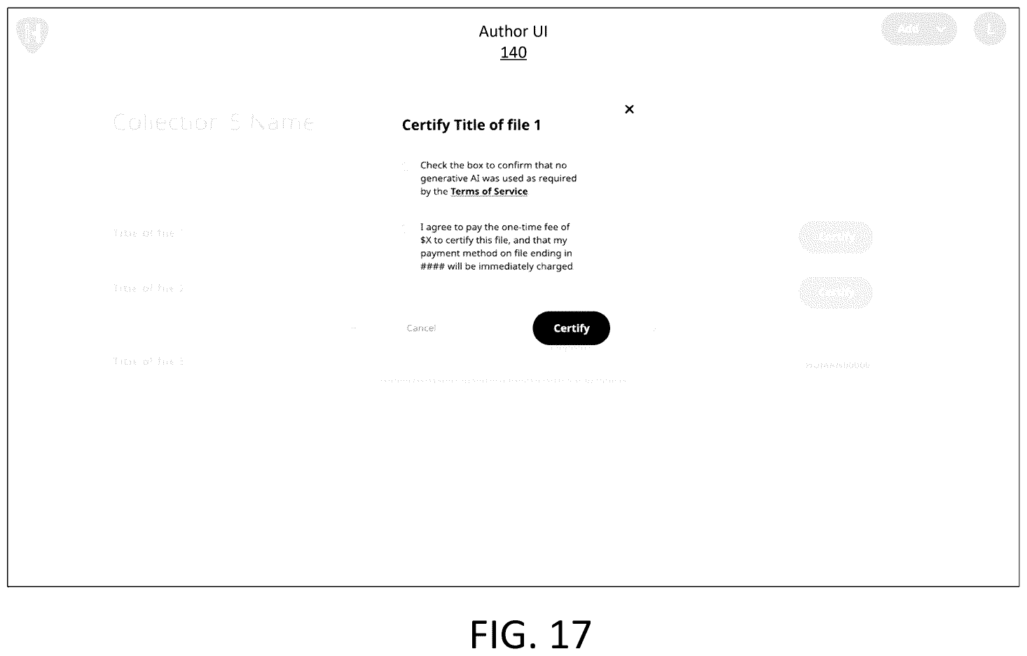

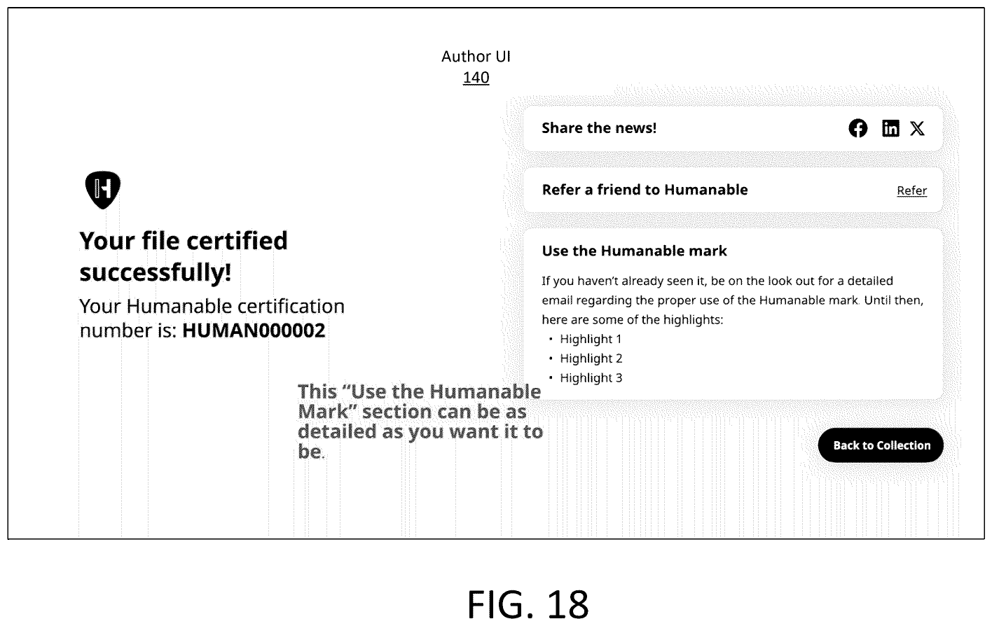

The method 200 may further comprise receiving, by the one or more servers 112 and through a certification process, that at least one of the one or more unique works was created without the use of GAI (step 208) and generating a notification that the certification was successful (e.g., as shown in FIG. 18) (step 210). For example, as shown in FIG. 12, after the one or more unique works have been uploaded, the author 101 can have the option to certify the one or more unique works were created without the use of GAI. In this regard, responsive to selecting a certification link (e.g., a hyperlink) (e.g., as shown in FIG. 12), the author UI 140 can generate a pop-up to allow the artist to confirm that no GAI was used for the selected media file (e.g., as shown in FIG. 17). In various embodiments, the pop-up that is generated may also provide a confirmation for acceptance of payment for the license to use the certification mark; however, the present disclosure is not limited in this regard.

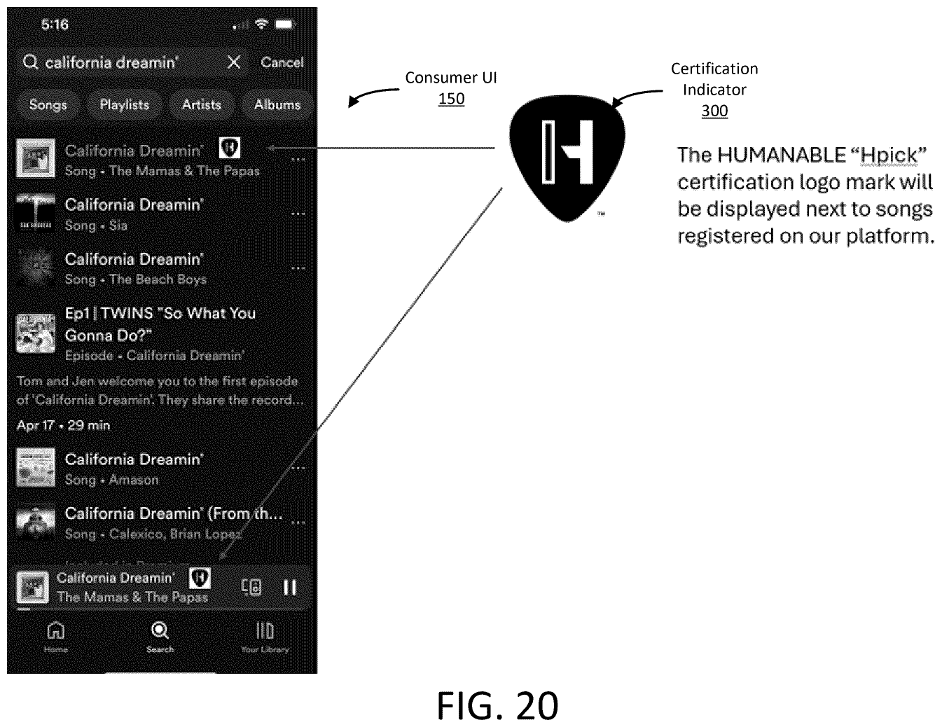

In response to the certification in step 208, one or more databases 118 of the computer system 110 are updated to associate a certification indicator (e.g., certification indicator 300 from FIG. 20) with at least one of the one or more media files (step 212). In this regard, the one or more databases 118 can be configured to synchronize (e.g., continuously, continually, periodically, or sporadically) with the one or more databases 134 of the media platform 130 to update media files that are associated with the certification indicator 300 from FIG. 20.

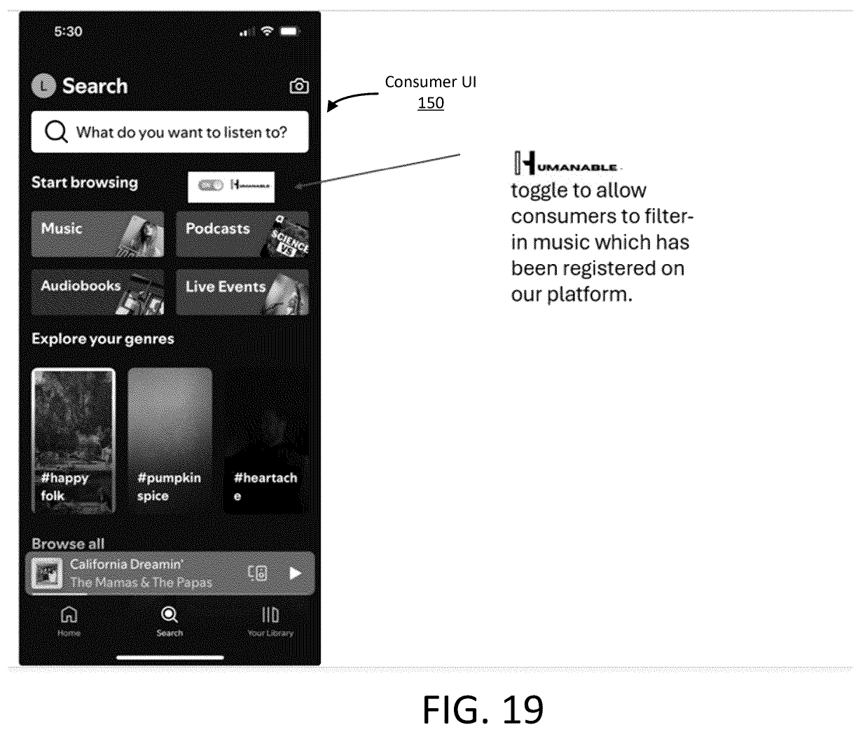

In various embodiments, based on the one or more databases 134 of the media platform 130 being updated, a consumer 103 can toggle on a consumer UI 150 of a media platform 130 (e.g., as shown in FIG. 19) between human-created music only, or both human-created music and GAI created music. In this regard, a consumer 103 can have the option to consume only human-created music (i.e., only music that is associated with the certification indicator 300 from FIG. 20), in accordance with various embodiments.

In various embodiments, method 200 may further comprise auditing, via an auditing process, the one or more databases 118 (step 214). In various embodiments, the auditing process can be performed by a specialist (e.g., a musicologist), or via an automated process. The present disclosure is not limited in this regard. In various embodiments, the auditing can comprise randomly selecting a plurality of media files and analyzing them for GAI influences and/or contributions. This step ensures that music certified as clean remains free of any AI influence, in accordance with various embodiments.

In many embodiments, the techniques described herein can provide a practical application and several technological improvements. At a practical level, consumers are offered a heretofore unavailable ability to filter GAI-generated media out of search results, allowing them to browse and enjoy strictly human-created works if desired. Moreover, the techniques described herein improve the operating of computer systems such as media databases, as multiple configurations of the database are now possible (i.e., GAI-inclusive configurations, and GAI-exclusive configurations). In this way, the techniques described herein can avoid problems with media files and/or databases where GAI influence or use may be difficult to detect or avoid if desired.

In many embodiments, the techniques described herein can be used continuously at a scale and/or complexity that cannot be reasonably performed using manual techniques or the human mind. For example, the techniques can include analyzing patterns of audio waveforms (including waveforms in an audio file that are of limited perceptibility to a human ear (for example, due to amplitude) or even imperceptible (i.e., outside the conventional 20 Hz-20 Khz range of natural human hearing)), patterns of pixels within multi-megapixel (i.e., 1,000,000+ pixel) images, comparing large sections of pixels to each other, learning statistical parameters for evaluating music files based on training on a large quantity of music files, performing extensive summations, Fourier and/or Laplace transformations, trigonometrical functions, transposing and/or multiplying large matrices, and so forth. Often, the calculations related to a single media file could not be performed with pen and paper within the lifetime of a human being.

In a number of embodiments, the techniques described herein can solve a technical problem that arises only within the realm of computers and computer networks, as GAI creation of media files does not exist outside the realm of computers and computer networks. Similarly, detection of such GAI influence necessarily does not exist outside the same realm.

The present system, or any part(s) or function(s) thereof, may be implemented using hardware, software, or a combination thereof and may be implemented in one or more computer systems or other processing systems. However, the manipulations performed by embodiments were often referred to in terms, such as matching or selecting, which are commonly associated with mental operations performed by a human operator. No such capability of a human operator is necessary, or desirable in most cases, in any of the operations described herein. Rather, the operations may be machine operations or any of the operations may be conducted or enhanced by artificial intelligence (AI) or machine learning. Artificial intelligence may refer generally to the study of agents (e.g., machines, computer-based systems, etc.) that perceive the world around them, form plans, and make decisions to achieve their goals. Foundations of AI include mathematics, logic, philosophy, probability, linguistics, neuroscience, and decision theory. Many fields fall under the umbrella of AI, such as computer vision, robotics, machine learning, and natural language processing. Useful machines for performing the various embodiments include general purpose digital computers or similar devices.

Further, illustrations of the process flows and the descriptions thereof may make reference to user WINDOWS® applications, webpages, websites, web forms, prompts, etc. Practitioners will appreciate that the illustrated steps described herein may comprise any number of configurations including the use of WINDOWS® applications, webpages, web forms, popup WINDOWS® applications, prompts, and the like. It should be further appreciated that the multiple steps as illustrated and described may be combined into single webpages and/or WINDOWS® applications but have been expanded for the sake of simplicity. In other cases, steps illustrated and described as single process steps may be separated into multiple webpages and/or WINDOWS® applications but have been combined for simplicity.

In various embodiments, components, modules, and/or engines of system 100 may be implemented as micro-applications, micro-apps, micro-services, or the like. Micro-apps are typically deployed in the context of a mobile operating system, including for example, a WINDOWS® mobile operating system, an ANDROID® operating system, an APPLE® iOS operating system, or any other operating system that may be readily apparent to one skilled in the art. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system which monitors various hardware components and then communicates a detected input from the hardware to the micro-app.

The systems, computers, computer-based systems, and the like disclosed herein may provide a suitable website or other internet-based graphical user interface which is accessible by users. Practitioners will appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, JAVA® applets, JAVASCRIPT® programs, active server pages (ASP), common gateway interface scripts (CGI), extensible markup language (XML), dynamic HTML, cascading style sheets (CSS), AJAX (Asynchronous JAVASCRIPT and XML) programs, helper applications, plug-ins, and the like. A server may include a web service that receives a request from a web server, the request including a URL and an IP address. The web server retrieves the appropriate web pages and sends the data or applications for the web pages to the IP address. Web services are applications that are capable of interacting with other applications over a communications means, such as the internet. Web services are typically based on standards or protocols such as XML, SOAP, AJAX, WSDL and UDDI. Web services methods are well known in the art, and are covered in many standard texts. As a further example, representational state transfer (REST), or RESTful, web services may provide one way of enabling interoperability between applications. In various embodiments, any communication discussed herein may be accomplished via the internet or an intranet. Communications may be completed using any suitable protocol, such as, for example, IPv4 (base 10), IPv6 (HMAC), and/or any other suitable or desired communications protocol.

In one embodiment, MICROSOFT® company's Internet Information Services (IIS), Transaction Server (MTS) service, and an SQL SERVER® database, are used in conjunction with MICROSOFT® operating systems, WINDOWS NT® web server software, SQL SERVER® database, and MICROSOFT® Commerce Server. Additionally, components such as ACCESS® software, SQL SERVER® database, ORACLE® software, SYBASE® software, INFORMIX® software, MYSQL® software, INTERBASE® software, etc., may be used to provide an Active Data Object (ADO) compliant database management system. In one embodiment, the APACHE® web server is used in conjunction with a LINUX® operating system, a MYSQL® database, and PERL®, PHP, Ruby, and/or PYTHON® programming languages.

In various embodiments, the server may include application servers (e.g., WEBSPHERE®, WEBLOGIC®, JBOSS®, POSTGRES PLUS ADVANCED SERVER®, etc.). In various embodiments, the server may include web servers (e.g., Apache, IIS, GOOGLE® Web Server, SUN JAVA® System Web Server, JAVA® Virtual Machine running on LINUX® or WINDOWS® operating systems). In various embodiments, service solutions may also include IaaS environments, PaaS environments, and/or the like.

Users, systems, computer-based systems, or the like may communicate with the server via a web client. The web client includes any device or software which communicates via any network such as, for example any device or software discussed herein. The web client may include internet browsing software installed within a computing unit or system to conduct online transactions and/or communications. These computing units or systems may take the form of a computer or set of computers, although other types of computing units or systems may be used, including personal computers, laptops, notebooks, tablets, smart phones, cellular phones, personal digital assistants, servers, pooled servers, mainframe computers, distributed computing clusters, kiosks, terminals, point of sale (POS) devices or terminals, televisions, or any other device capable of receiving data over a network. The web client may include an operating system (e.g., WINDOWS®, WINDOWS MOBILE® operating systems, UNIX® operating system, LINUX® operating systems, APPLE® OS® operating systems, etc.) as well as various conventional support software and drivers typically associated with computers. The web-client may also run MICROSOFT® INTERNET EDGE® software, MOZILLA® FIREFOX® software, GOOGLE® CHROME® software, APPLE® SAFARI® software, or any other of the myriad software packages available for browsing the internet.

As those skilled in the art will appreciate, the web client may or may not be in direct contact with the server (e.g., application server, web server, etc., as discussed herein). For example, the web client may access the services of the server through another server and/or hardware component, which may have a direct or indirect connection to an internet server. For example, the web client may communicate with the server via a load balancer. In various embodiments, web client access is through a network or the internet through a commercially available web-browser software package. In that regard, the web client may be in a home or business environment with access to the network or the internet. The web client may implement security protocols such as Secure Sockets Layer (SSL) and Transport Layer Security (TLS). A web client may implement several application layer protocols including HTTP, HTTPS, FTP, and SFTP.

Any databases discussed herein may include relational, hierarchical, graphical, blockchain, object-oriented structure, and/or any other database configurations. In various embodiments, any database may also include a no-SQL database, a key-value database, an in-memory database, a GPU database, and/or the like. Any database may also include a flat file structure wherein data may be stored in a single file in the form of rows and columns, with no structure for indexing and no structural relationships between records. For example, a flat file structure may include a delimited text file, a CSV (comma-separated values) file, and/or any other suitable flat file structure. Common database products that may be used to implement the databases include DB2® by IBM® (Armonk, NY), various database products available from ORACLE® Corporation (Redwood Shores, CA), MICROSOFT ACCESS® or MICROSOFT SQL SERVER® by MICROSOFT® Corporation (Redmond, Washington), MYSQL® by MySQL AB (Uppsala, Sweden), MONGODB®, Redis, Apache Cassandra®, HBASE® by APACHE®, MapR-DB by the MAPR® corporation, or any other suitable database product. Moreover, any database may be organized in any suitable manner, for example, as data tables or lookup tables. Each record may be a single file, a series of files, a linked series of data fields, or any other data structure.

Any database discussed herein may comprise a distributed ledger maintained by a plurality of computing devices (e.g., nodes) over a peer-to-peer network. Each computing device maintains a copy and/or partial copy of the distributed ledger and communicates with one or more other computing devices in the network to validate and write data to the distributed ledger. The distributed ledger may use features and functionality of blockchain technology, including, for example, consensus-based validation, immutability, and cryptographically chained blocks of data. The blockchain may comprise a ledger of interconnected blocks containing data. The blockchain may provide enhanced security because each block may hold individual transactions and the results of any blockchain executables. Each block may link to the previous block and may include a timestamp. Blocks may be linked because each block may include the hash of the prior block in the blockchain. The linked blocks form a chain, with only one successor block allowed to link to one other predecessor block for a single chain. Forks may be possible where divergent chains are established from a previously uniform blockchain, though typically only one of the divergent chains will be maintained as the consensus chain. In various embodiments, the blockchain may implement smart contracts that enforce data workflows in a decentralized manner. The system may also include applications deployed on user devices such as, for example, computers, tablets, smartphones, Internet of Things devices (“IoT” devices), etc. The applications may communicate with the blockchain (e.g., directly or via a blockchain node) to transmit and retrieve data. In various embodiments, a governing organization or consortium may control access to data stored on the blockchain. Registration with the managing organization(s) may enable participation in the blockchain network.

The system and method may be described herein in terms of functional block components, screen shots, optional selections, and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, JAVA®, JAVASCRIPT®, JAVASCRIPT® Object Notation (JSON), VBScript, Macromedia COLD FUSION, COBOL, MICROSOFT® company's Active Server Pages, assembly, PERL®, PHP, awk, PYTHON®, Visual Basic, SQL Stored Procedures, PL/SQL, any UNIX® shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JAVASCRIPT®, VBScript, or the like. Cryptography and network security methods are well known in the art and are covered in many standard texts.

In various embodiments, the software elements of the system may also be implemented using a JAVASCRIPT® run-time environment configured to execute JAVASCRIPT® code outside of a web browser. For example, the software elements of the system may be implemented using NODE.JS® components. NODE.JS® programs may implement several modules to handle various core functionalities. For example, a package management module, such as NPM®, may be implemented as an open-source library to aid in organizing the installation and management of third-party NODE.JS® programs. NODE.JS® programs may also implement a process manager such as, for example, Parallel Multithreaded Machine (“PM2”); a resource and performance monitoring tool such as, for example, Node Application Metrics (“appmetrics”); a library module for building user interfaces, and/or any other suitable and/or desired module.

As will be appreciated by one of ordinary skill in the art, the system may be embodied as a customization of an existing system, an add-on product, a processing apparatus executing upgraded software, a stand-alone system, a distributed system, a method, a data processing system, a device for data processing, and/or a computer program product. Accordingly, any portion of the system or a module may take the form of a processing apparatus executing code, an internet-based embodiment, an entirely hardware embodiment, or an embodiment combining aspects of the internet, software, and hardware. Furthermore, the system may take the form of a computer program product on a computer-readable storage medium having computer-readable program code means embodied in the storage medium. Any suitable computer-readable storage medium may be utilized, including hard disks, CD-ROM, SONY BLU-RAY DISC®, optical storage devices, magnetic storage devices, and/or the like.

The present disclosure has been described with reference to various embodiments. However, one of ordinary skill in the art appreciates that various modifications and changes can be made without departing from the scope of the present disclosure. Accordingly, the specification is to be regarded in an illustrative rather than a restrictive sense, and all such modifications are intended to be included within the scope of the present disclosure. Likewise, benefits, other advantages, and solutions to problems have been described above with regard to various embodiments. However, benefits, advantages, solutions to problems, and any element(s) that may cause any benefit, advantage, or solution to occur or become more pronounced are not to be construed as a critical, required, or essential feature or element.

As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. Also, as used herein, the terms “coupled,” “coupling,” or any other variation thereof, are intended to cover a physical connection, an electrical connection, a magnetic connection, an optical connection, a communicative connection, a functional connection, and/or any other connection. When language similar to “at least one of A, B, or C” or “at least one of A, B, and C” is used in the specification or claims, the phrase is intended to mean any of the following: (1) at least one of A; (2) at least one of B; (3) at least one of C; (4) at least one of A and at least one of B; (5) at least one of B and at least one of C; (6) at least one of A and at least one of C; or (7) at least one of A, at least one of B, and at least one of C.

What is claimed is:

1. A method for certifying media files, the method comprising:
receiving, by one or more servers, an author data set corresponding to identifying information for at least one of a human author or an authorized representative of the human author;
verifying, by the one or more servers and through a verification process, an identity of the human author or the authorized representative of the human author;
receiving, by the one or more servers and through an uploading process, one or more media files corresponding to one or more unique works associated with the human author or the authorized representative of the human author;
receiving from the human author or the authorized representative of the human author, by the one or more servers and through a certification process, an affirmation that at least one of the one or more unique works associated with the human author was created without the use of generative artificial intelligence (GAI);
generating, by the one or more servers, a notification that the certification was successful; and
updating one or more databases to associate a certification indicator with the at least one of the one or more unique works in response to the certification process being completed to produce a plurality of certified media files.

2. The method of claim 1, further comprising:
transmitting, by the one or more servers, the plurality of certified media files to one or more external databases, wherein the one or more external databases are in electronic communication with a media platform.

3. The method of claim 2, further comprising:
sorting, by a toggle, the one or more external databases into the plurality of certified media files and a plurality of non-certified media files, wherein the plurality of certified media files comprise the certification indicator; and
displaying at least one certified media file in the plurality of certified media files on a user device.

4. The method of claim 1, further comprising:
storing, by the one or more servers, an aggregation of certified media files.

5. The method of claim 4, further comprising:
auditing, through an auditing process, the aggregation of certified media files to verify a certification status.

6. The method of claim 5, wherein the auditing comprises use of a machine learning system to evaluate one or more media files in the aggregation of certified media files for the presence of any content created using GAI.

7. The method of claim 5, further comprising:
revoking, responsive to detection of GAI content in the auditing process, the certification status of one or more of the certified media files.

8. The method of claim 1, further comprising:
prior to the generating a notification that the certification was successful, evaluating the one or more media files.

9. The method of claim 8, wherein the evaluating comprises evaluating, by a human being with expertise in a creative field applicable to the one or more media files, the one or more media files for indicators of the presence of GAI content therein.

10. The method of claim 8, wherein the evaluating comprises evaluating, by a machine learning system trained on a corpus of media files known to be free of GAI content, the one or more media files for indicators of the presence of GAI content therein.

11. The method of claim 2, wherein the certification indicator is a visible feature on the media platform spatially located near other visible metadata associated with the plurality of certified media files.
